(19) United States
(12) Patent Application Publication
(10) Pub. No.: US 2015/0167702 A1
(43) Pub. Date: Jun. 18, 2015

(54) ACTUATOR ASSEMBLIES

(71) Applicant: Triumph Actuation Systems - Yakima, LLC, Berwyn, PA (US)

(72) Inventors: Brent Michael Ozanich, Selah, WA (US); Calvin Scott Thompson, Yakima, WA (US); Bradley Lynn Pfaff, Yakima, WA (US)

(21) Appl. No.: 14/104,176

(22) Filed: Dec. 12, 2013

(51) Int. Cl. F15B 15/26; F15B 15/14

(52) U.S. Cl. CPC F15B 15/261; F15B 15/1423; F15B 2015/268

(57) ABSTRACT

Actuator assemblies with a casing having an elongated body defining an interior with a longitudinal axis and an open end providing access to the interior, a main piston having at least a portion slidably received within the interior through the open end for sliding axial movement relative to the longitudinal axis between a retracted position and an extended position and a lock segment mounted to a portion of the main piston such that sliding movement of the lock segment moves the lock segment radially, relative to the longitudinal axis, between a locked position and an unlocked position.

### BACKGROUND OF THE INVENTION

In conventional aircraft, linear actuators may be used for a variety of purposes including retracting and extending landing gear. In this manner, the actuator may be moved between two positions. The actuator may lock to hold the extended and retracted positions. For example, once in either position, the actuator locking mechanism may lock the gear in either the gear up, or, gear down positions.

### BRIEF DESCRIPTION OF THE INVENTION

In one aspect an embodiment of the invention relates to an actuator assembly including a casing having an elongated body defining an interior with a longitudinal axis and an open end providing access to the interior, a main piston having at least a portion slidably received within the interior through the open end for sliding axial movement relative to the longitudinal axis between a retracted position and an extended position, and a locking mechanism selectively prohibiting reciprocation of the main piston relative to the casing, having at least one moveable lock segment, a lock piston, and a pilot piston adjacent the lock piston and moveable between a first position and a second position.

In another aspect an embodiment of the invention relates to an actuator assembly including a casing having an elongated body defining an interior with a longitudinal axis and an open end providing access to the interior, a main piston having at least a portion slidably received within the interior through the open end for sliding axial movement relative to the longitudinal axis between a retracted position and an extended position, a lock segment slidably mounted to a portion of the main piston such that sliding movement of the lock segment moves the lock segment radially, relative to the longitudinal axis, between locked and unlocked positions and a lock segment actuator slidable relative to the longitudinal axis between an actuated position and a non-actuated position.

### BRIEF DESCRIPTION OF THE DRAWINGS

In the drawings:

FIG. 1 is a perspective view of a landing gear assembly in an extended position.

FIG. 2 is a perspective view of the landing gear assembly of FIG. 1 in a refracted position.

FIG. 3 is a side view of an actuator assembly in a retracted state, which may be used in the landing gear of FIG. 1 according to an embodiment of the invention.

FIG. 3A is a top view of the actuator assembly of FIG. 3.

FIG. 4 is a side view of the actuator assembly of FIG. 3 in an extended state.

FIGS. 5 and 5A are cross-sectional views of a portion of the actuator assembly of FIG. 3 in a fully retracted state and a locked position.

FIGS. 6 and 6A are cross-sectional views of a portion of the actuator assembly of FIG. 3 at the verge of unlocking

FIGS. 7 and 7A are cross-sectional views of a portion of the actuator assembly of FIG. 3 in an unlocked position.

FIG. 8 is a cross-sectional view of a portion of the actuator assembly of FIG. 3 in mid-stroke.

FIG. 9 is a cross-sectional view of a portion of the actuator assembly of FIG. 3 in a fully extended state.

FIG. 10 is a cross-sectional view similar to that of FIG. 5 with a maintenance lock illustrated in a locked position.

### DESCRIPTION OF EMBODIMENTS OF THE INVENTION

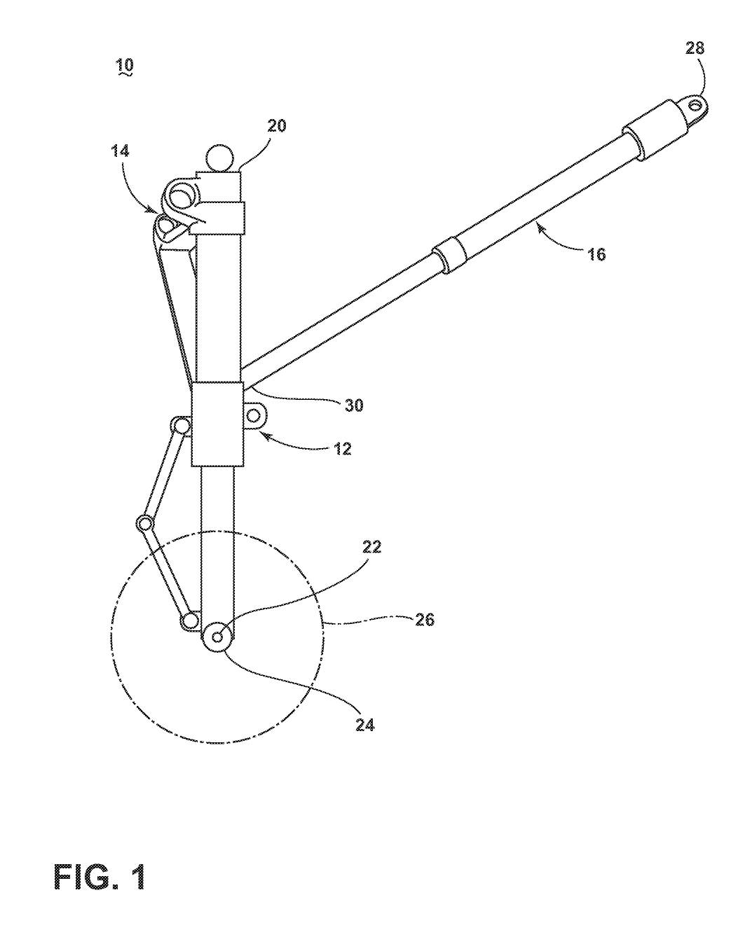

Embodiments of the invention include actuator assemblies, by way of non-limiting example, such actuator assemblies may be utilized in the environment of a landing gear assembly. For example, FIG. 1 illustrates a landing gear assembly 10 for an aircraft (not shown) according to an embodiment of the invention and including a leg 12, a link assembly 14, and an actuator in the form of an actuator assembly 16. The leg 12 may have a first end 20 rotatably coupled to the aircraft for rotating between retracted and extended positions. The leg 12 may be mounted to the fuselage or the wings of the aircraft and in the retracted position the leg 12 may be accommodated within a landing gear bay within the fuselage or wings of the aircraft. For example, the aircraft may include a helicopter and in that case the leg 12 would be mounted to the fuselage of the aircraft.

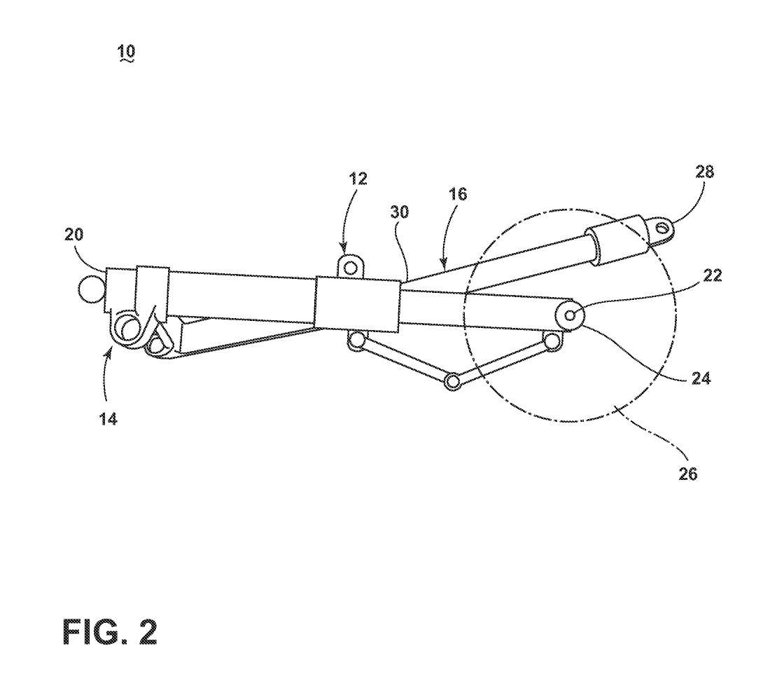

A wheel mount 22 may be included on the leg 12 proximate to a second end 24 of the leg 12 and a wheel 26 may be mounted thereon. The actuator assembly 16 may be operably coupled at a first end 28 to the aircraft and at a second end 30 to the link assembly 14. The link assembly 14 may include multiple rotatably coupled links, with one of the links rotatably coupled to the aircraft, including being coupled through the actuator assembly 16, and another of the links rotatably coupled to the leg 12. Operation of the actuator assembly 16 moves the link assembly 14 and the leg 12 between the extended position as shown in FIG. 1 and the retracted position shown in FIG. 2 and is capable of locking the landing gear assembly 10.

Actuator assemblies may fail to lock the landing gear in the extended position causing the aircraft to collapse during taxi maneuvers. For example, an actuator may use locking segments, which have a small angle interface with a locking mechanism, which may be held in place by a lock spring. This interface when exposed to high load rise rates or oscillating loads creates an axial force sufficient to overcome the spring allowing the lock mechanism to move and unlock the actuator without a command to do so. The other means by which the actuator may unlock is through buildup of hydraulic pressure during oscillating loads. The load oscillation at a high enough frequency would cause a differential pressure to build across the lock piston sufficient to unlock the unit.

While the above described environment of landing gear has been described it will be understood that an actuator according to embodiments of the invention may be used wherever there is a need for an actuator to hold an end item in a specified locked position. Additional examples include landing gear bay doors or Ram Air Turbine (RAT) positioning devices.

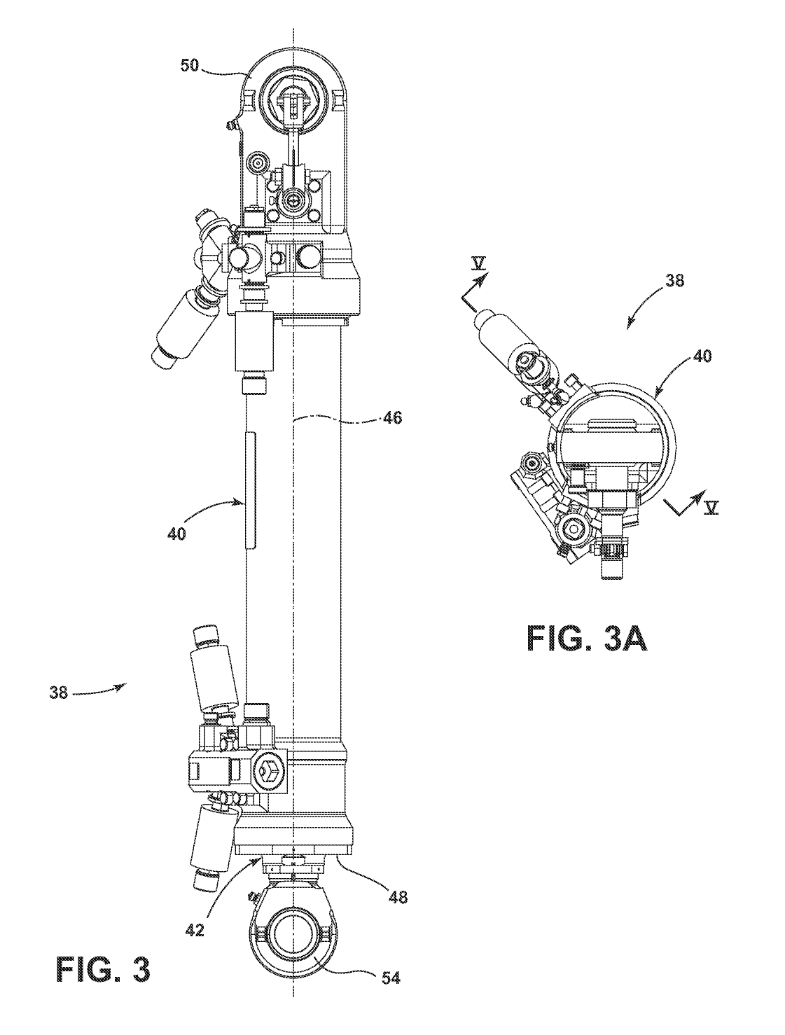

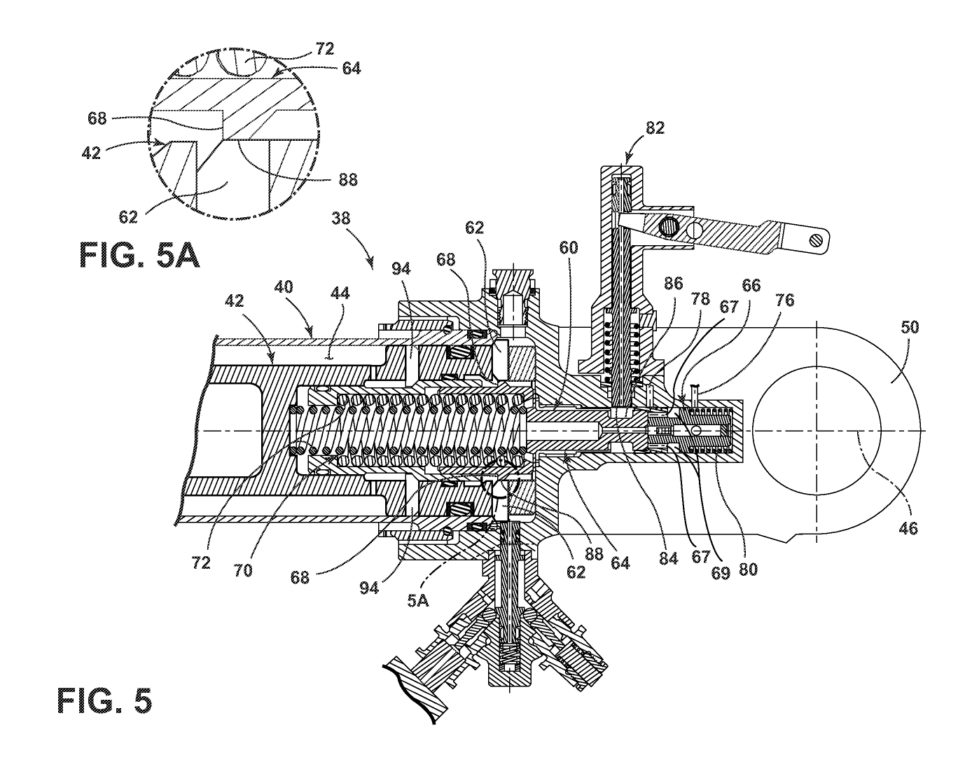

FIGS. 3 and 3A illustrate an exemplary actuator assembly 38 according to an embodiment of the invention. The actuator assembly 38 has been illustrated as including a casing 40 and a main piston 42. The casing 40 may have an elongated body defining an interior 44 (FIG. 5) with a longitudinal axis 46 and an open end 48 providing access to the interior 44. The casing 40 may include or be operably coupled with an end connector 50, which is the portion of the actuator assembly 38 that may be coupled to the aircraft. The casing 40 may be formed in any suitable manner and has been shown in the form of a cylinder for illustrative purposes.

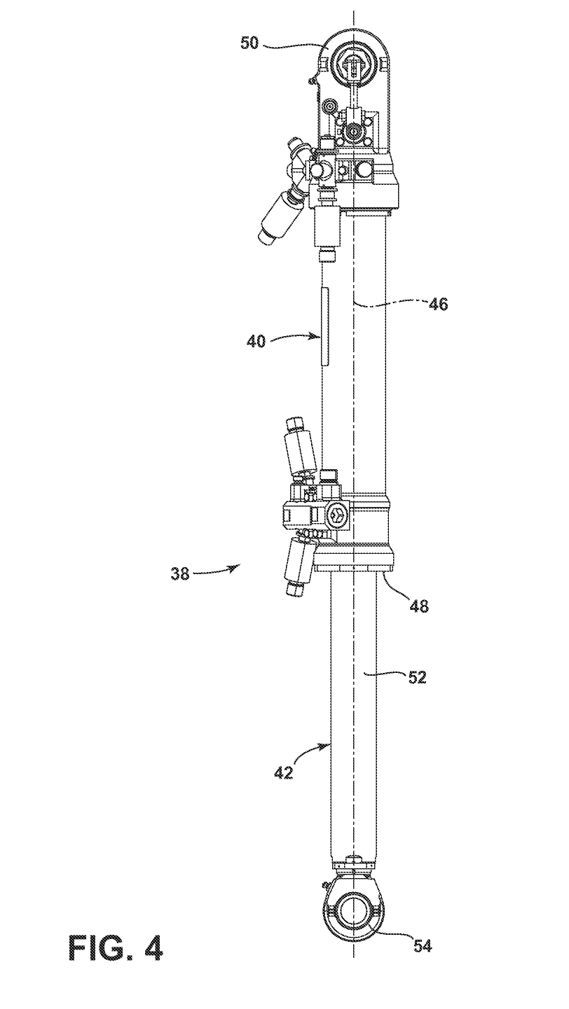

As better illustrated in FIG. 4, the main piston 42 may have at least a portion 52 slidably received within the interior 44 through the open end 48 for sliding axial movement relative to the longitudinal axis 46. In this manner, the main piston 42 may be slidably coupled to the casing 40 for reciprocation relative to the casing 40 such that the main piston 42 may slide between a retracted position (FIG. 3) and an extended position (FIG. 4). The main piston 42 may include or be operably coupled with an end connector 54, which is the portion of the actuator assembly 38 that may be coupled to the landing gear assembly 10. For example, the end connector 54 may be mounted directly to the link assembly 14, which has been schematically illustrated as a circle, or may be operably coupled to the link assembly 14 through a mounting device (not shown).

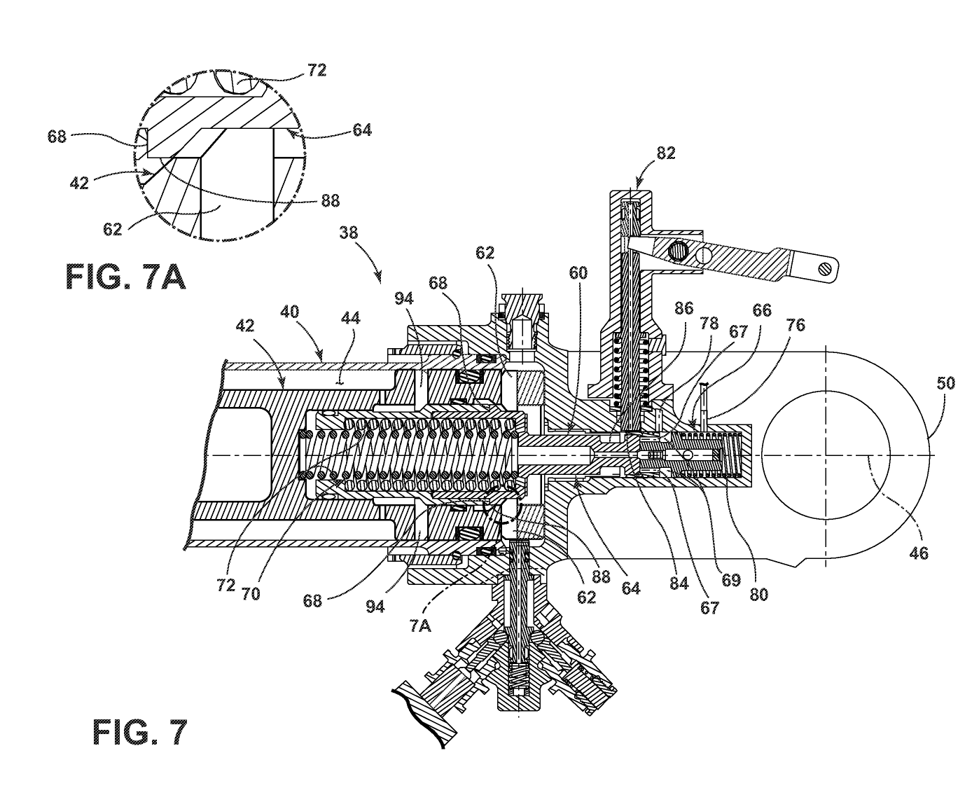

As illustrated in FIG. 5, a locking mechanism 60 may selectively prohibit reciprocation of the main piston 42 relative to the casing 40. The locking mechanism 60 may include at least one moveable lock segment 62, a lock piston 64, and a pilot piston 66. In the illustrated example, the locking mechanism 60 includes multiple moveable lock segments 62. The moveable lock segments 62 may be radially spaces around the lock piston 64. The moveable lock segments 62 may be mounted within a portion of the main piston 42 such that sliding movement of the at least one moveable lock segment 62 moves the at least one moveable lock segment 62 radially, relative to the longitudinal axis 46, between a locked position (FIG. 5) and an unlocked position (FIG. 7).

The lock piston 64 is also slidable relative to the longitudinal axis 46 between an actuated position (FIG. 5) where the moveable lock segment(s) 62 is in the locked position and a non-actuated position (FIG. 7), where the moveable lock segment(s) 62 is in the unlocked position. The lock piston 64 may form a lock segment actuator as its movement causes movement of the lock segments 62. The lock piston 64 may include a number of protrusions 68, which when the lock piston 64 is actuated may locate the moveable lock segments 62 in the locked position. A portion of the lock piston 64 may be received within the main piston 42 such that the lock piston 64 and the main piston 42 may be slid in tandem relative to the longitudinal axis 46. Further, the locking mechanism may include a biasing mechanism 70 configured to bias the lock piston 64 towards the locked position. In the illustrated example, the biasing mechanism 70 comprises multiple springs 72 biasing the lock piston 64 towards the locked position, although it will be understood that this need not be the case.

The pilot piston 66 is illustrated adjacent the lock piston 64 when the lock piston is in the actuated position. The pilot piston 66 has been illustrated as including internal ports 67. Any number of internal ports 67 may be included in the pilot piston 66 including a single internal port. The pilot piston 66 is moveable between a first position (FIG. 5) and a second position (FIG. 7), where the pilot piston 66 moves the lock piston 64 to the non-actuated position. More specifically, the movement of the pilot piston 66 to the second position moves the lock piston 64 to the non-actuated position.

The casing 40 may include at least one port 76 configured to provide hydraulic pressure to move the pilot piston 66 from the first position to the second position. In the illustrated example, the casing 40 includes both the at least one port 76 in the form of a primary port 76 and a secondary port 78. The secondary port 78 is configured to provide additional hydraulic pressure configured to move the main piston 42 towards the extended position. A biasing element 80 may be included and may bias the pilot piston 66 into the second position.

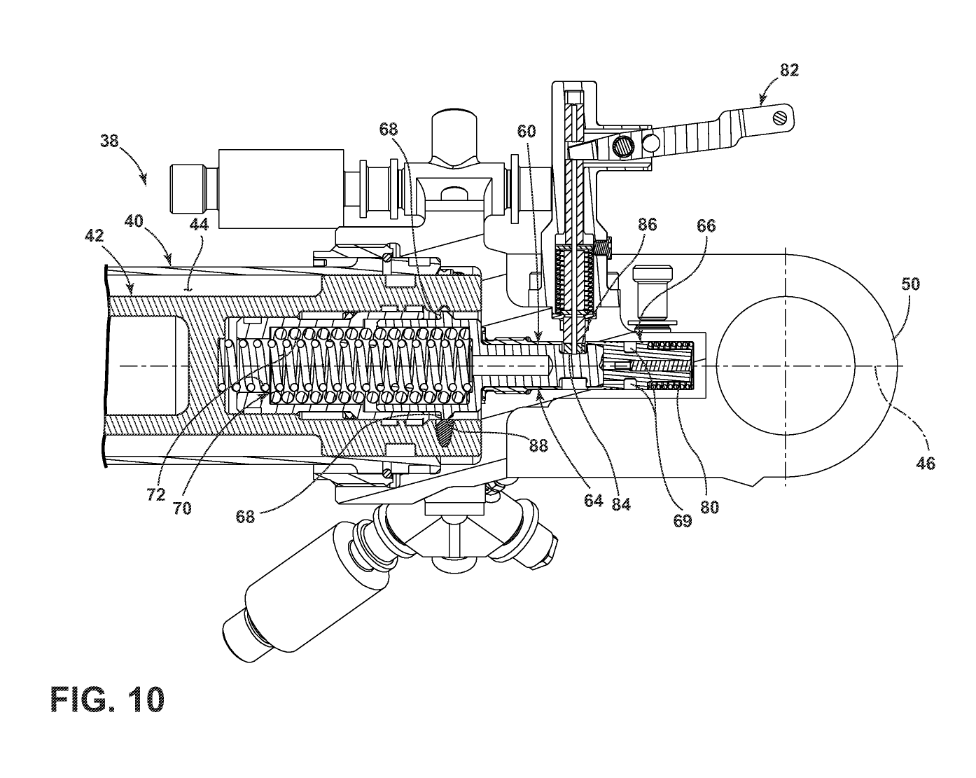

Further, a maintenance lockout mechanism 82 may be included and configured to selectively engage the lock piston 64 to prevent the lock piston 64 from moving to the non-actuated position. In the illustrated example, the maintenance lockout mechanism 82 includes a moveable bar 84 selectively receivable within a recess 86 of the lock piston 64 (FIG. 10).

In the locked position, as illustrated in FIG. 5, a portion of the moveable lock segment(s) 62 extend from the portion of the main piston 42 into sliding interference with the casing 40. This prevents the main piston 42 from reciprocating relative to the casing 40. Movement of the lock piston 64 to the actuated position slidably moves the lock segments 62 to the locked position where a portion of the lock segment extends from the portion of the main piston 42 into sliding interference with the casing 40. The protrusions 68 of the lock piston 64 abut the lock segment 62 and hold the lock segments 62 in the locked position. More specifically, each lock segment 62 abuts a portion of the lock piston 64 to define a contact interface 88 such that only radial forces are transferred through the contact interface 88. The contact interface 88 is defined by a zero degree contact interface 88 between the lock segment 62 and the protrusions 68 of the lock piston 64. Such a contact interface 88 ensures that axial force sufficient to move and unlock the actuator assembly 38 without a command to do so are not created.

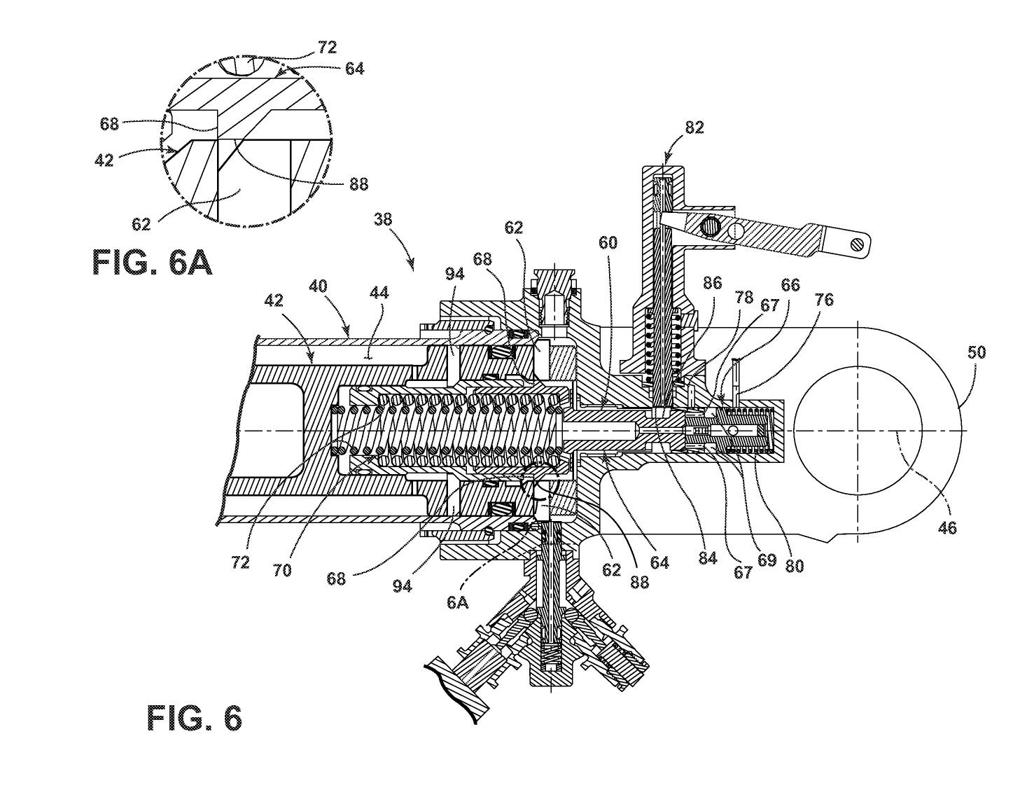

To unlock the actuator assembly 38, hydraulic pressure is introduced through the primary port 76. Hydraulic pressure acts on the back of the pilot piston 66. As the pilot piston 66 is pushed towards the second position (FIG. 7), it pushes on the lock piston 64 moving it towards the non-actuated position. FIG. 6 illustrates the locking mechanism 60 of the actuator assembly 38 at the verge of unlocking

FIG. 7 illustrates the locking mechanism 60 of the actuator assembly 38 in an unlocked position. More specifically, the moveable lock segment(s) 62 are in the unlocked position such that they do not interfere with the casing 40. Thus, in the unlocked position, the main piston 42 may reciprocate relative to the casing 40. In such a position, the secondary port 78 may be used to provide additional hydraulic pressure to the interior of the casing 40. Such hydraulic pressure may enter the inlet 69 and travel through the internal ports of the pilot piston 66. In this manner, the pilot piston 66 acts as a valve sequencer inside the actuator assembly 38 before higher pressures are introduced through the secondary port 78. This limits the wear on the lock segments 62 as the pilot piston 66 restricts pressure to the head end of the actuator assembly 38 until the locking mechanism 60 is disengaged.

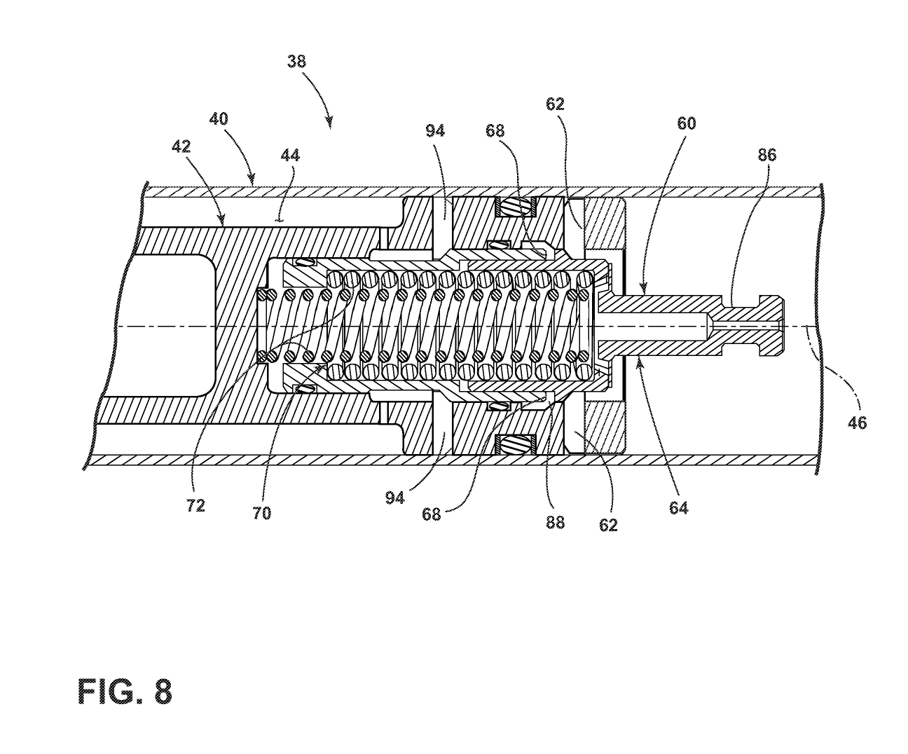

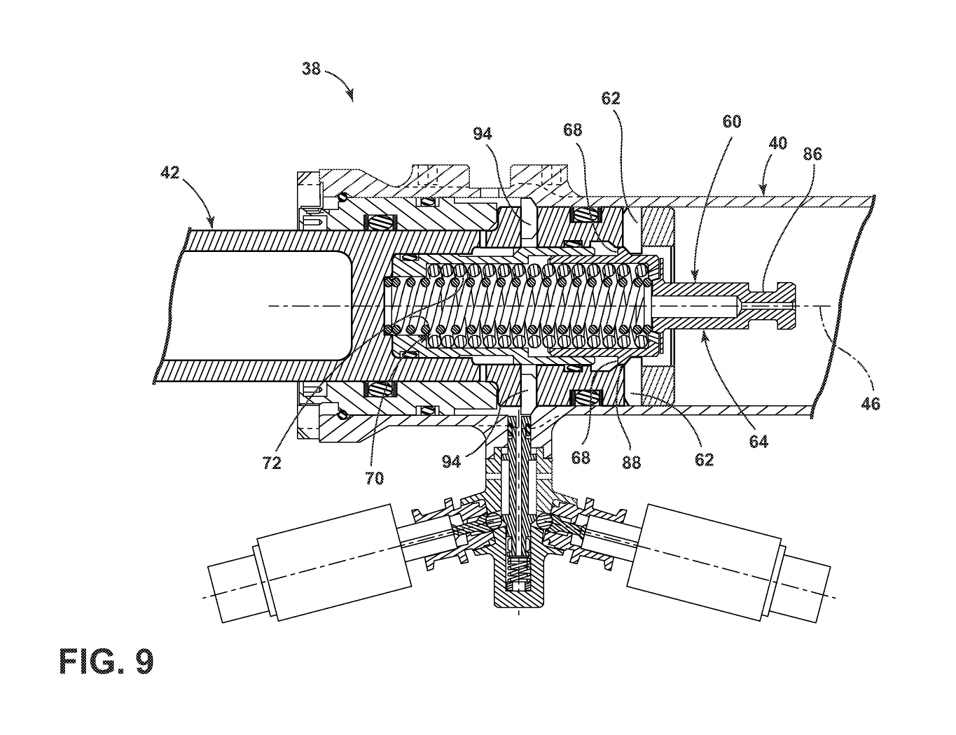

FIG. 8 is a cross-sectional view of a portion of the actuator assembly 38 in mid-stroke between being retracted and extended. Hydraulic pressure introduced into the casing 40 by the secondary port 78 continues to move the main piston 42 towards the extended position. For completeness of explanation, FIG. 9 illustrates the actuator assembly 38 in a fully extended state. In the fully extended state additional lock segments 94, which may also be moveably mounted within a portion of the main piston 42, may move radially to a locked position. In the locked position, a portion of the additional lock segments 94 extend from the portion of the main piston 42 into sliding interference with the casing 40. In this manner, the actuator assembly 38 may be locked in both the extended position and the refracted position.

The above-described embodiments provided a variety of benefits including the ability of the actuator to hold in the locked position up to its structural load capability. The above-described embodiments eliminate the possibility of the actuator unlocking and causing damage to the aircraft resulting in financial penalties and product retrofit action. More specifically, the above-described embodiments eliminate any angled interface between the lock segments and the lock piston such as a contact interface as described above eliminates the ability of any externally applied loads to cause the actuator assembly to unlock. An angled interface was previously presented to control the amount of wear in the locking mechanism throughout its required life; however, the above-described embodiments include the pilot piston, which control the units wear in the absence of the angle. More specifically, wear on the lock segments is primarily caused during dynamic unlock and re-lock, to minimize wear during unlock a sequence valve was designed into the pilot piston. Furthermore, in the above-described embodiments, the lock piston is pressure balanced. More specifically, the above-described embodiments eliminate seals from the lock piston, which eliminates the possibility of differential pressure, potentially caused by oscillation, unlocking the actuator assembly. Therefore, the only force acting on the lock piston in the mid stroke position during extension are the spring forces. In this manner, the lock piston is not affected by pressure build up on the actuator assembly.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An actuator assembly, comprising:
a casing having an elongated body defining an interior with a longitudinal axis and an open end providing access to the interior;
a main piston having at least a portion slidably received within the interior through the open end for sliding axial movement relative to the longitudinal axis between a retracted position and an extended position; and
a locking mechanism selectively prohibiting reciprocation of the main piston relative to the casing, comprising:
at least one moveable lock segment mounted within a portion of the main piston such that sliding movement of the at least one moveable lock segment moves the at least one moveable lock segment radially, relative to the longitudinal axis, between a locked position and an unlocked position, where in the locked position a portion of the at least one moveable lock segment extends from the portion of the main piston into sliding interference with the casing preventing the main piston from reciprocating relative to the casing and an unlocked position where the main piston may reciprocate relative to the casing;
a lock piston slidable relative to the longitudinal axis between an actuated position where the at least one moveable lock segment is in the locked position and a non-actuated position, where the at least one moveable lock segment is in the unlocked position; and
a pilot piston adjacent the lock piston and moveable between a first position and a second position, where the pilot piston moves the lock piston to the non-actuated position.

2. The actuator assembly of claim 1 wherein the casing comprises at least one port configured to provide hydraulic pressure to move the pilot piston from the first position to the second position.

3. The actuator assembly of claim 2 wherein the casing comprises a secondary port configured to provide additional hydraulic pressure configured to move the main piston towards the extended position.

4. The actuator assembly of claim 1, further comprising a biasing element configured to bias the pilot piston into the second position.

5. The actuator assembly of claim 1, further comprising a lockout mechanism configured to selectively engage the lock piston to prevent the lock piston from moving to the non-actuated position.

6. The actuator assembly of claim 5 wherein the lockout mechanism comprises a moveable bar selectively receivable within a recess of the lock piston.

7. The actuator assembly of claim 1 wherein the locking mechanism comprises a biasing mechanism configured to bias the lock piston towards the locked position.

8. The actuator assembly of claim 7 wherein the biasing mechanism comprises multiple springs biasing the lock piston towards the locked position.

9. The actuator assembly of claim 1 wherein the locking mechanism comprises multiple moveable lock segments.

10. The actuator assembly of claim 9 wherein the multiple moveable lock segments are radially spaced around the lock piston.

11. An actuator assembly comprising:
a casing having an elongated body defining an interior with a longitudinal axis and an open end providing access to the interior;
a main piston having at least a portion slidably received within the interior through the open end for sliding axial movement relative to the longitudinal axis between a retracted position and an extended position;
a lock segment slidably mounted to a portion of the main piston such that sliding movement of the lock segment moves the lock segment radially, relative to the longitudinal axis, between locked and unlocked positions; and
a lock segment actuator slidable relative to the longitudinal axis between an actuated position and a non-actuated position;
wherein the sliding movement of the lock segment actuator to the actuated position slidably moves the lock segment to the locked position where a portion of the lock segment extends from the portion of the main piston into sliding interference with the casing and the lock segment abuts a portion of the lock segment actuator to define a contact interface such that only radial forces are transferred through the contact interface.

12. The actuator assembly of claim 11 wherein the contact interface is defined by a zero degree interface between the lock segment and the portion of the lock segment actuator.

13. The actuator assembly of claim 11, further comprising a pilot piston adjacent the lock segment actuator and moveable between a first position and a second position, where the pilot piston moves the lock segment actuator to the non-actuated position.

14. An actuator assembly comprising:
a casing having an elongated body defining an interior with a longitudinal axis and an open end providing access to the interior;
a main piston having at least a portion slidably received within the interior through the open end for sliding axial movement relative to the longitudinal axis between a retracted position and an extended position;
a lock segment slidably mounted to a portion of the main piston such that the sliding movement of the lock segment moves the lock segment radially, relative to the longitudinal axis, between locked and unlocked positions;
a lock segment actuator having a lock piston slidable relative to the longitudinal axis between an actuated position and non-actuated position; and
wherein the sliding of the lock piston to the actuated position slides the lock segment to the locked position, where a portion of the lock segment extends from the portion of the main piston into sliding interference with the casing and the lock segment abuts a portion of the lock piston, and the lock piston is pressure balanced.

15. The actuator assembly of claim 14, further comprising a pilot piston adjacent the lock piston and moveable between a first position and a second position, where the pilot piston moves the lock piston to the non-actuated position.
